(19) United States
(12) Patent Application Publication
(10) Pub. No.: US 2004/0255020 A1
(43) Pub. Date: Dec. 16, 2004

(54) Method and system for measuring replication latencies in a network having multiple directory servers

(76) Inventor: Alain Lissoir, Brussels (BE)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/459,546

(22) Filed: Jun. 12, 2003

(51) Int. Cl. G06F 15/173

(52) U.S. Cl. 709/224

(57) ABSTRACT

A method and system are disclosed for measuring replication latency in a network having interconnected directory servers that store objects. A client terminal connected to a local directory server is used to measure replication latency. The client terminal accesses the local directory server or a remote directory server and retrieves information to identify all of the other directory servers in the network. The client terminal updates an object in one of the directory servers, such as the local directory server. The other directory servers replicate the object. The client terminal monitors the other directory servers as the object is replicated, and calculates the replication latency for each of the directory servers.

### TECHNICAL FIELD

The technical field relates generally to computer networks having multiple directory servers that replicate objects. More particularly, the technical field relates to measurement of latencies of replication of objects updated on the directory servers.

### BACKGROUND

In the field of network computing, directory servers, such as servers operating the ACTIVE DIRECTORY software by Microsoft Corporation, are used to store network objects in all enterprise having multiple sites. An object can be, for example, a user account containing the first name, the last name, and/or the user identifier of a particular user. The directory servers are connected to each other by wide area network (WAN) and are connected to client computer terminals and other system devices at their respective sites via local area networks (LANs). In a network running Microsoft's ACTIVE DIRECTORY software, the clients are WINDOWS clients, running Microsoft WINDOWS operating system.

Each directory server maintains the objects in their local database. When an object is added, deleted, or modified, the object change is first made to one of the directory servers. As used herein, the term “update” or “object update” refers to any change to an object, including the creation of a new object or a deletion or modification of an existing object. The object update is then replicated on all of the other directory servers so that all directory servers have the same version of the object. For example, if a user's account information such as a password or phone number changes, that change is replicated on all directory servers so that each of the directory servers have the current information.

An enterprise may have several, or even hundreds of, directory servers that each store the object, and the directory servers may be scattered around the world. In this case, it might require different lengths of time to replicate the object changes for different directory servers. Further, some object changes are processed more quickly than other changes, depending upon their relative importance. A password change or a user account deletion present security concerns that suggest the change should be made sooner rather than later. Other changes, such as a change to a user's telephone number, may be less important and might not justify consumption of the bandwidth required to process the change immediately.

As a result, a time period elapses between the time the object is changed on one directory server and the time that the change is replicated on the other directory servers. This time period is referred to as the replication latency. It is desirable to know the replication latency between different directory servers. By knowing this latency, the network administrator can determine when changes to objects on the network will be completed. The latency also helps to verify if the directory design matches the performance expectations. In some embodiments, many changes may typically occur from one or more central sites where data is entered. From these central sites, it is desirable to know how much time will be required to replicate the change on each of the other directory servers. Although changes are often made at central sites, it is also desirable to be able to determine when changes made at other sites take effect.

Existing systems fail to measure replication latency in a useful manner. Existing systems require the installation of software at each of the directory servers in order to measure replication latency. This is cumbersome, because networks may have hundreds, or more, interconnected servers. Deployment of such software throughout an entire enterprise is difficult. An improved method of measuring replication latency in a directory server network is needed.

### SUMMARY

A method is disclosed for measuring replication latency in a network having a interconnected directory servers that store objects. A client terminal connected to a local directory server is used to measure replication latency. The client terminal accesses the local directory server or a remote directory server and retrieves information to identify all of the other directory servers in the network. The client terminal updates an object in one of the directory servers, such as the local directory server. The other directory servers replicate the object. The client terminal monitors the other directory servers as the object is replicated, and calculates the replication latency for each of the other directory servers.

A tangible, computer-readable medium is also disclosed having stored thereon computer-executable instructions for performing a method of measuring replication latency in a network having a plurality of interconnected directory servers that store objects. The instructions identify directory servers connected to the network and selects an operation type for replication. The operation type may be selected by a user and has a replication priority so that replication operations having different priorities may be replicated. An object is updated in one of the directory servers according to the operation type, and the other directory servers are monitored as they replicate the object, to determine when the object is replicated, on each of the other directory servers. The replication latency is then calculated for each of the other directory servers for the operation type.

A computer system connected to a network having a plurality of interconnected directory servers that store objects is also disclosed. The terminal includes a processor and a memory having stored therein computer-executable instructions for performing a method of measuring replication latency for an object updated on one of the directory servers and replicated on other directory servers connected to the network. The terminal updates an object in one of the directory servers, such that the updating causes the other directory servers to replicate the object. The terminal determines when the object is replicated on each of the other servers and calculates the replication latency for each of the other servers, after determining when the object update is replicated.

### DESCRIPTION OF THE DRAWINGS

The detailed description will refer to the following drawings, wherein like numerals refer to like elements, and wherein:

FIG. 1 shows an embodiment of a block diagram of an enterprise of interconnected computer servers and terminals;

FIG. 2 shows an embodiment of a more detailed block diagram of one of the sites shown in FIG. 1;

FIG. 3 shows a flow chart of an embodiment for calculating replication latency;

FIG. 4 shows a flow chart of a more detailed embodiment for calculating replication latency; and

FIG. 5 shows an embodiment of a block diagram of an example enterprise of interconnected directory servers.

### DETAILED DESCRIPTION

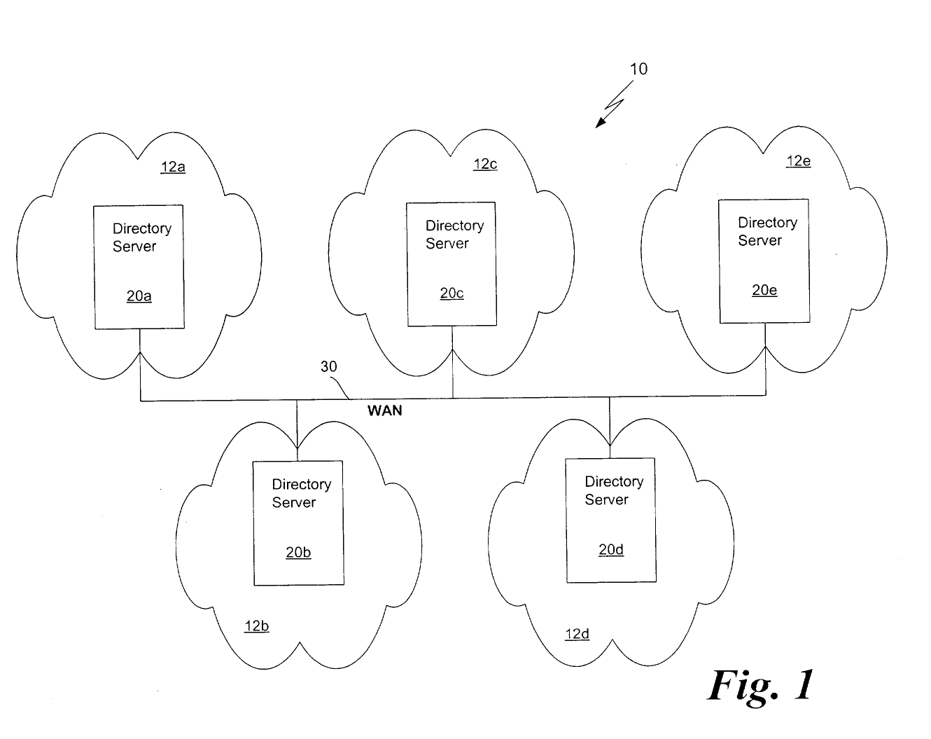

FIG. 1 shows an embodiment of a block diagram of an enterprise 10 of interconnected computer servers and terminals. As used herein, an “enterprise” 10 includes any business, agency, or other organization using a collection of interconnected computers. The enterprise 10 includes multiple directory servers 20a-e connected to each other by a network 30, such as the wide area network WAN, shown in FIG. 1.

Directory servers 20a-e are servers that store objects used within the enterprise 10. Directory servers 20a-e include servers using the ACTIVE DIRECTORY software by Microsoft Corporation. By way of example, objects include user accounts.

The enterprise 10 includes multiple sites 12a-e, each of which has a separate directory server 20a-e. Within each site 12a-e, a plurality of client terminals (not shown) connect to the directory server (e.g. 20a). As used herein a “local directory server” refers to the directory server (e.g., 20a) within the same site (e.g., 12a) that is used by way of reference. A “remote directory server” refers to a directory server (e.g., 20b) that is associated with a different site (e.g., 12b). For example, for a client terminal (not shown) within a site 12a, the directory server 20a within the same site 12a is the “local directory server” with respect to that client terminal (not shown). For the same client terminal located in site 12a (not shown), a directory server 20b associated with a different site 12b is a “remote directory server.”

A site 12a-e refers to any a subset of computer terminals and other interconnected devices in the enterprise 10, connected to a directory server 20a-e. By way of example, sites 12a-e may be different geographic locations in an enterprise 10 having multiple offices. A large corporation, for example, may have hundreds or more locations around the world, connected to each other by a network. Each office or location includes client terminals (not shown) for use by the corporation's employees and agents, and also includes a directory server (e.g., 20a) that stores objects used in the corporation's computer system. In another embodiment, a single geographic location may have multiple sites (e.g., 12a-e), each with its own directory server (e.g., 20a-e).

In use, objects are stored in the directory servers 20a-e for use in the enterprise 10. Objects include items such as user account information. The objects are stored in each of the directory servers 20a-e. When an object is created or modified, the object or modification is initially performed on a single directory server (e.g., 12a) and is replicated throughout the enterprise 10 on the other servers (12b-e). A latency is associated with the replication of the object on each of the directory servers 12a-e.

To measure the replication latency for each of the directory servers 20a-e, one of the client terminals (not shown) identifies directory servers (e.g., 20a-e) in the enterprise 10. An object is created on one of the directory servers (e.g., 20a) using the client terminal (not shown). In one embodiment, the client terminal (not shown) creates the object on its local directory server (e.g., 20a). In another embodiment, the client terminal (not shown) creates the object in a remote directory server (e.g., 20b). The object is replicated on each of the other directory servers 20b-e. The client terminal (not shown) monitors each of the other directory servers 20b-e to determine when the objects are replicated. The time required to replicate the object is referred to herein as the “latency” or “replication latency.” In one embodiment, the replication latency is calculated by recording a time at which the object is created on the local directory server 20a (the “object creation time), and comparing it to a time at which the object is replicated on each of the other directory servers 20b-e (the “object replication time”).

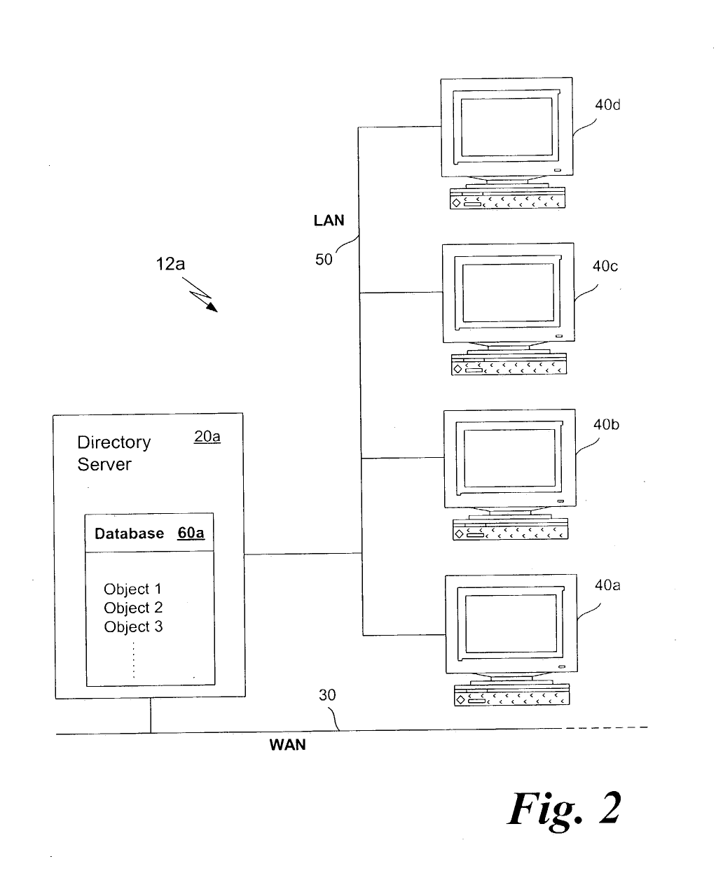

FIG. 2 shows an embodiment of a more detailed block diagram of one of the sites 12a shown in FIG. 1. The site 12a includes a directory server 20a connected to other directory servers (20b-e in FIG. 1) by a WAN 30. The directory server 20a has a database 60 that stores objects, listed as “Object 1, Object 2, Object 3,” etc. in FIG. 2. Client terminals 40a-d are connected to the directory server 20a by a local area network (LAN) 50. In use, replication latency is measured for the creation of an object on one of the directory servers (e.g., 20a) by calculating the time required to replicate the object on each of the other directory servers (20b-e in FIG. 1).

One of the client terminals, e.g., 40a, identifies the other directory servers (20b-e in FIG. 1) in the enterprise (10 in FIG. 1). The other directory servers (20b-e) are identified by accessing the local directory server 20a. The client terminal 40a updates an object (e.g., Object 1) on the local directory server 20a and records an object update time from the local directory server 20a when the object is created. The local directory server 20a replicates the object on the other directory servers (20b-e in FIG. 1) in the enterprise (10 in FIG. 1). The client terminal 40a monitors each of the other directory servers (20b-e in FIG. 1) and determines when the object is replicated on each of the other directory servers (20b-e in FIG. 1). In one embodiment, each of the directory servers (20a-e in FIG. 1) maintains a “whenChanged” field, or similar data entry, for objects stored on the server, that indicates when each object was last updated or changed. The client terminal 40a monitors the other directory servers (20b-e in FIG. 1) by periodically checking the “whenChanged” data field (or similar data entry) to determine whether the object has been updated. If the “whenChanged” value is different at a subsequent check than at a previous check, then the object has been updated. By comparing the object replication time and the object update time, the replication latency is calculated.

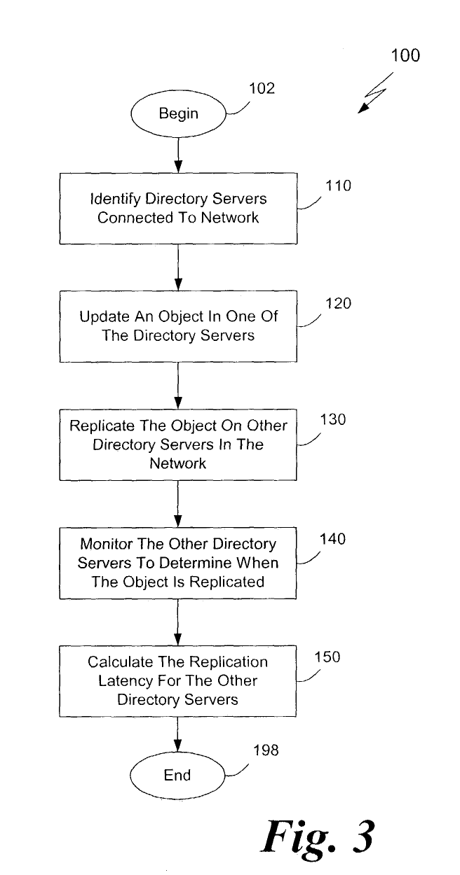

FIG. 3 shows a flow chart of an embodiment 100 for calculating replication latency. The embodiment 100 begins 102 and identifies 110 directory servers (20a-e in FIG. 1) connected to the network (30 in FIG. 1), using a client terminal (e.g., 40a in FIG. 2). An object is updated 120 by the client terminal 40a in one of the directory servers (e.g., 20a in FIG. 1). The other directory servers 20b-e replicate the object at step 130. The client terminal 40a monitors 140 the other directory servers 20b-e to determine when the object is replicated. The client terminal 40a calculates 150 the replication latency for each of the other directory servers 20b-e, and the embodiment 100 ends 198.

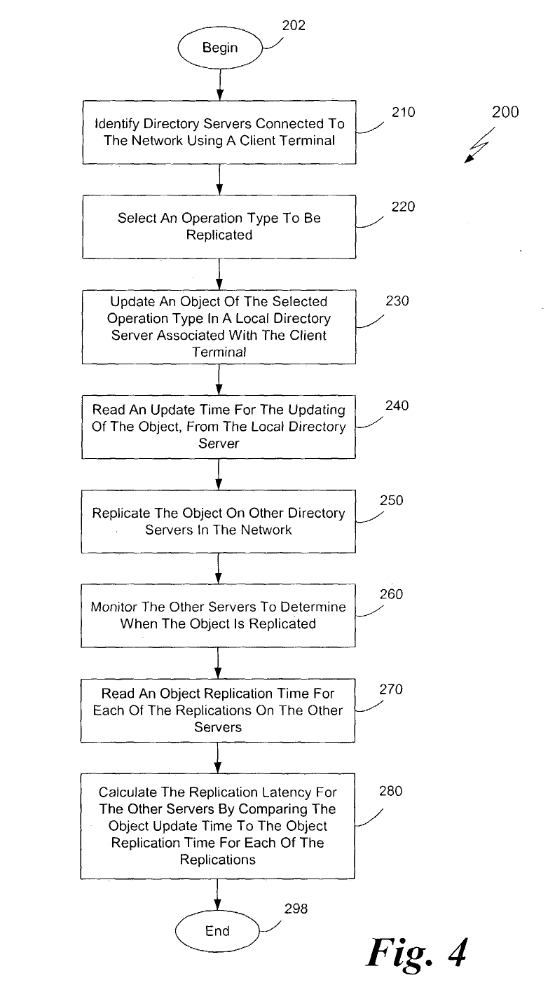

FIG. 4 shows a flow chart of a more detailed embodiment 200 for calculating replication latency. The embodiment 200 begins 202 and a client terminal (e.g., 40a) identifies directory servers 20a-e connected to the network 30. A specific type of operation on an object is selected 220. In this embodiment, some update operations on objects may have longer or shorter replication latencies. For instance, some operations on objects are associated with higher priorities than other. The reset of a user password may have a higher priority than the change of a user's telephone number. It may be important for the directory servers 20a-e to immediately replicate changes to passwords to prevent unauthorized users from continuing to have access to those directory servers (e.g., 20a-e) that have slower replication latencies. On the other hand, a change to a user's telephone number might be a lower priority. In this example, operations having a higher priority are replicated more quickly than operations having a lower priority. Higher priority operations may be given increased bandwidth or other system resources to immediately effect their changes. The embodiment 200 in the example of FIG. 4 measures the replication latencies based on the selected operation type.

An operation of the selected type is created 230 on the local directory server 20a that is associated with the client terminal 40a. The client terminal 40a reads 240 the object update time from the local directory server 20a. The object is then replicated 250 on the other directory servers 20b-e connected to the network 30. The client terminal 40a monitors 260 the other directory servers 20b-e to determine when the object is replicated on each of the other directory servers 20b-e. When the object is replicated, the client terminal 40a reads the object replication time from each of the other directory servers 20b-e. The replication latency is then calculated for each of the other directory servers 20b-e by comparing the object update time to the object replication time, and the method 200 ends 298.

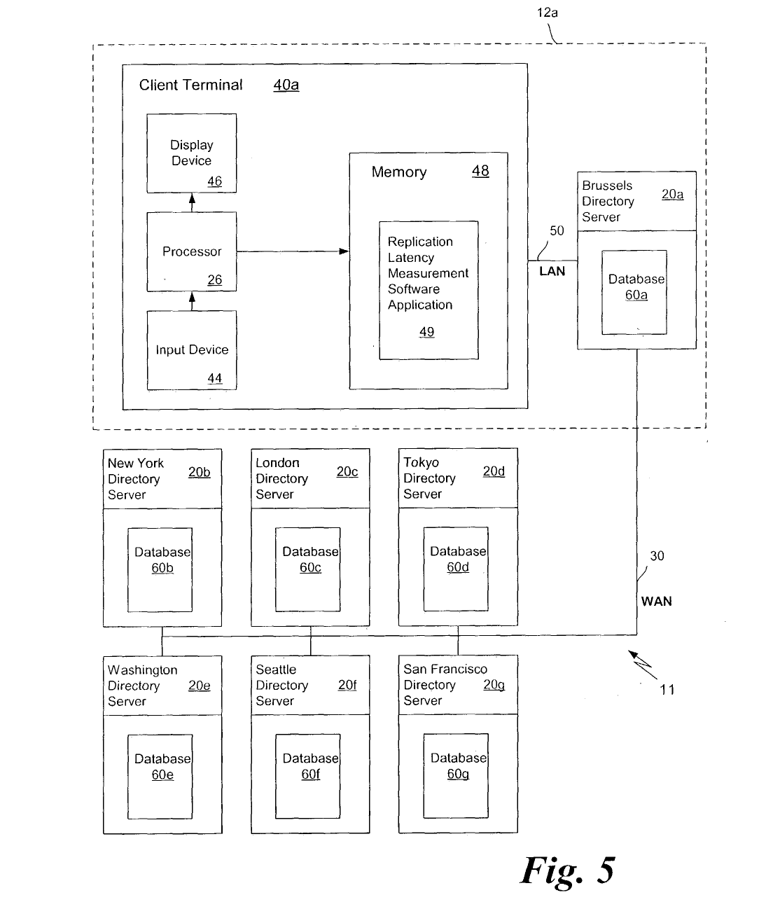

FIG. 5 shows an embodiment of a block diagram of an example enterprise 11 of interconnected directory servers 20a-20g. In this example, each of the directory servers 20a-20g is in a different geographic location around the world, in this case Brussels, New York, London, Tokyo, Washington, Seattle, and San Francisco each has its own directory server 20a-20g, respectively. The directory servers 20a-20g are connected to each other by a WAN 30. Each geographic site (e.g., 12a) has a directory server (e.g., 20a) and a plurality of interconnected local client terminals (e.g., 40a) connected to the directory server (e.g., 20a) by a LAN 50. In the example of FIG. 5, additional detail is shown for one of the sites 12a, namely the Brussels site 12a. Only one of the client terminals 40a in the Brussels site 12a is shown and is connected to a Brussels directory server 20a. As described above, for the Brussels client terminal 40a, the Brussels directory server 20a is a “local” directory server.

The client terminal 40a in FIG. 5 is used to measure replication latency for replication of objects throughout the enterprise on each of the directory servers 20a-20f. The client terminal 40a includes a processor 42 that receives input from an input device 44, such as a keyboard, touch pad, mouse, joystick, pen-based input device, or other similar input devices. The terminal 40a displays information on a display device 46. The terminal 40a also includes a memory 48 that stores computer-executable instructions for measuring replication latency. The computer-executable instructions are referred to as a replication latency measurement software application 49 that resides in the memory 48. In use, the processor 42 accesses the memory 48 and executes the instructions 49.

The replication latency may be measured by installing the software application 49 on only one of the client terminals, such as the client terminal 40a shown in FIG. 5. From this one client terminal 40a, a user can measure the replication latency by running the application 49. In use, the application 49 accesses one of the directory servers, such as the local directory server 20a, to identify all other directory servers 20b-20g in the enterprise 11. The software application 49 allows selection of an operation type for which replication will be measured. As described above, objects are replicated in different types of operations, depending upon the nature of the object change (update non-essential data, create/delete user account or user network permissions, etc.). Different operations are assigned different replication priorities and therefore might be expected to have different replication times. For example, operations having lower replication priorities may generally have longer replication latencies for all directory servers, while operations having higher replication priorities may have shorter replication latencies, depending on the configuration of the directory servers.

For the selected operation type, the local client terminal 40a updates an object according to the selected operation, on the local directory server 20a. The object update is made in the database 60a of the local directory server 20a, and the client terminal 20a records an update time. Each of the other directory servers 20b-20g also has a database that stores the objects in the enterprise 11. When an object is updated on one of the directory servers 20a, the other directory servers 20b-20g replicate the object update in their own databases 60b-60g. Because the client terminal 40a has identified the other directory servers 20b-20g in the enterprise 11, the client terminal 40a is able to monitor each of the other directory servers 20b-20g to determine when the object is updated in each of the other databases 60b-60g. The client terminal 40a reads an object replication time when the object is replicated on each of the directory servers 20b-20g. The client terminal 40a calculates the replication latency for each of the other directory servers 20b-20g. The replication latencies are stored and may be accessed by a user of the client terminal 40a as needed. In one embodiment, the software application 49 creates a table showing the replication latencies for each of the remote directory terminals 20b-20g, for objects updated on the local directory server 20a, of the selected operation type.

The object update and replication latency measurement process may be repeated for different operation types. Also, the process may be repeated to update an object on one of the remote directory servers (e.g., 20b-20g) and measure the replication latencies for objects updated on the remote directory server (e.g., 20-20g). In one embodiment, the client terminal 40a repeats the measurement process in a constant loop in order to maintain a current schedule of replication latencies.

Although the present invention has been described with respect to particular embodiments thereof, variations are possible. The present invention may be embodied in specific forms without departing from the essential spirit or attributes thereof. In addition, although aspects of an implementation consistent with the present invention are described as being stored in memory, one skilled in the art will appreciate that these aspects can also be stored on or read from other types of computer program products or computer-readable media, such as secondary storage devices, including hard disks, floppy disks, or CD-ROM; a carrier wave from the Internet or other network; or other forms of RAM or read-only memory (ROM). It is desired that the embodiments described herein be considered in all respects illustrative and not restrictive and that reference be made to the appended claims and their equivalents for determining the scope of the invention.

1. A method of measuring replication latency in a network having a plurality of interconnected directory servers that store objects, the method comprising:
identifying directory servers connected to the network using a local client terminal connected to a local directory server by a local area network (LAN), wherein the local directory server is one of the directory servers in the network;
updating an object on one of the directory servers;
monitoring the other directory servers that replicate the object, to determine when the object is replicated on each of the other directory servers; and
calculating replication latency for each of the other directory servers, based on the monitoring.

2. The method of claim 1, wherein the directory servers run ACTIVE DIRECTORY software.

3. The method of claim 1, wherein the step of updating comprises updating the object on the local directory server.

4. The method of claim 1, wherein the steps of identifying, updating, and calculating comprise identifying, updating, and calculating using a software application installed only on the local client terminal.

5. The method of claim 1, wherein the object is replicated on each of the other directory servers in the network.

6. The method of claim 1,
further comprising:
reading an object update time from the one of the directory servers when the object is updated, and
reading a replication time for each of the other directory servers when the object is replicated on each of the other directory servers; and
wherein the step of calculating comprises, for each of the other directory servers, comparing the object update time with the object replication time.

7. The method of claim 1, wherein the steps of identifying, updating, monitoring, and calculating are performed periodically to create a continuously updated schedule of replication latencies between the one of the directory servers and the other directory servers in the network.

8. The method of claim 1, further comprising selecting an operation type for the object, and wherein the step of updating comprises updating the object based on the selected operation type.

9. The method of claim 8, wherein the operation type is associated with a replication priority.

10. The method of claim 1, wherein the step of updating the object on the one of the directory servers comprises updating the object on a remote directory server, using the local client terminal.

11. A tangible, computer-readable medium having stored thereon computer-executable instructions for performing a method of measuring replication latency in a network having a plurality of interconnected directory servers that store objects, the method comprising:
identifying directory servers connected to the network;
selecting an operation type for replication, wherein the operation type has a replication priority;
updating an object in one of the directory servers according to the operation type;
monitoring the other directory servers while the other directory servers replicate the object to determine when the object is replicated on each of the other directory servers; and
calculating replication latency for each of the other directory servers for the operation type, based on the monitoring.

12. The medium of claim 11,
wherein the method further comprises:
reading an object update time from the one of the directory servers when the object is updated on the one of the directory servers, and
reading a replication time for each of the other directory servers when the object is replicated on each of the other directory servers; and
wherein the step of calculating comprises, for each of the other directory servers, comparing the object update time with the object replication time.

13. The medium of claim 11, wherein the steps of identifying, updating, monitoring, and calculating are performed periodically to create a continuously updated schedule of replication latencies between the one of the directory servers and the other directory servers in the network.

14. The medium of claim 11, wherein the step of updating the object comprises updating the object using a single client terminal connected to a local directory server.

15. The medium of claim 14, wherein the step of updating the object comprises updating the object on the local directory server.

16. A computer system connected to a network having a plurality of interconnected directory servers that store objects and a terminal connected to the network, the terminal comprising:
a processor; and
a memory having stored therein computer-executable instructions for performing a method of measuring replication latency for an object updated on one of the directory servers and replicated on other directory servers connected to the network, the method comprising:
updating an object in one of the directory servers, wherein the step of updating causes the other directory servers to replicate the object;
determining when the object is replicated on each of the other servers; and
calculating replication latency for each of the other servers, after the determining.

17. The computer system of claim 16, wherein the step of updating comprises updating according to an operation type having a replication priority.

18. The computer system of claim 17, wherein the steps of updating, determining, and calculating are repeated for a plurality of operation types having a plurality of replication priorities.

19. The computer system of claim 16, wherein the step of updating comprises updating the object in a database associated with a local directory server, and wherein the object is replicated on remote directory servers.

20. The computer system of claim 16, wherein the step of updating the object comprises creating a user account on a local directory server, and wherein the step of determining comprises determining when the user account is replicated in each of the other directory servers.

21. An apparatus that measures replication latency among directory servers in a network of interconnected directory servers, the apparatus comprising:
means for identifying directory servers connected to the network using a local client terminal connected to a local directory server by a local area network (LAN), wherein the local directory server is one of the directory servers in the network;
means for updating an object on one of the directory servers;
means for periodically checking a data field associated with the object on each of the other directory servers that replicate the object, to determine when the object is replicated on each of the other directory servers; and
means for calculating replication latency for each of the other directory servers, based on the monitoring.

22. The apparatus of claim 21, further comprising a means for selecting an operation type for replication, wherein the operation type has a replication priority, and wherein the means for updating comprises means for updating according to the selected operation type.
